(19) United States
(12) Patent Application Publication
(10) Pub. No.: US 2026/0132835 A1
(43) Pub. Date: May 14, 2026

(54) APPARATUS FOR SHOCK ABSORBING

(71) Applicant: HL Mando Corporation, Pyeongtaek-si (KR)

(72) Inventors: Jongsun LEE, Pyeongtaek-si (KR); Kwangsu LEE, Pyeongtaek-si (KR); Heejae CHAE, Pyeongtaek-si (KR)

(21) Appl. No.: 19/311,536

(22) Filed: Aug. 27, 2025

(30) Foreign Application Priority Data
Oct. 2, 2024 (KR) 10-2024-0134191

(51) Int. Cl. F16F 9/46; B60G 13/08; B60G 17/08; F16F 9/18; F16F 9/36

(52) U.S. Cl. CPC F16F 9/46; F16F 9/18; F16F 9/369; B60G 13/08; B60G 17/08; B60G 2202/24; B60G 2204/62; B60G 2206/41; B60G 2500/104; B60G 2500/11; B60G 2600/182; B60G 2800/162; B60G 2800/916; F16F 2222/12; F16F 2228/066; F16F 2230/18; F16F 2230/30; F16F 2232/08; F16F 2234/02

(57) ABSTRACT

A shock absorbing apparatus according to the present disclosure may comprise a block having a through hole vertically penetrating the block, and a first flow path, a second flow path, and a third flow path; and a first tube extending vertically through the through hole and having a penetration portion that penetrates an inner circumferential surface and an outer circumferential surface of the first tube so that an interior of the first tube is in fluid communication with the first flow path.

### CROSS-REFERENCE TO RELATED APPLICATION

This application claims priority to and benefit from Korean Patent Application No. 10-2024-0134191, filed on Oct. 2, 2024, the disclosure of which is incorporated herein by reference in its entirety.

### TECHNICAL FIELD

The present disclosure relates to a shock absorbing apparatus and, more particularly, to a shock absorbing apparatus that is mounted on a vehicle to absorb shocks transmitted from a road surface to the vehicle.

### RELATED ART

A shock absorbing apparatus, also referred to as a damper, is mounted on a vehicle to suppress vibrations transmitted to the vehicle body during driving, thereby improving ride comfort. In addition, the shock absorbing apparatus suppresses rapid vibrations of the wheels during vehicle driving, thereby enhancing driving stability.

An electronically controlled shock absorbing apparatus includes an electronically controlled valve. The damping force of the electronically controlled shock absorbing apparatus can be adjusted through the control of the electronically controlled valve. However, the adjustment of the damping force through the control of the electronically controlled valve has limitations in terms of tuning performance for achieving optimal ride comfort.

### SUMMARY

The present disclosure is to solve the above-described problems, and the present disclosure is directed to providing a shock absorbing apparatus with improved tuning performance related to the control of damping force during a compression stroke.

The objects of the present disclosure are not limited to the above-described objects, and other objects that are not mentioned will be able to be clearly understood by those skilled in the art to which the present disclosure pertains from the following description.

According to an aspect of the present disclosure, provided is a shock absorbing apparatus comprising a block having a through hole vertically penetrating the block, and a first flow path, a second flow path, and a third flow path; a first tube extending vertically through the through hole and having a penetration portion that penetrates an inner circumferential surface and an outer circumferential surface of the first tube so that an interior of the first tube is in fluid communication with the first flow path; a piston assembly disposed inside the first tube and configured to performing a compression stroke or a rebound stroke, the piston assembly including: a piston valve that partitions the first tube into a rebound chamber on the upper side and a compression chamber on the lower side, and a piston rod coupled to the piston valve; a second tube disposed to surround a portion of the first tube that extends below the block and forming a first intermediate chamber between the second tube and the first tube, the first intermediate chamber providing fluid communication between the compression chamber and the second flow path; a first valve disposed at a lower end of the first tube, the first valve partitioning the compression chamber and the first intermediate chamber and allowing fluid in the compression chamber to flow into the first intermediate chamber; a third tube disposed to surround a portion of the first tube that extends above the block and forming a second intermediate chamber between the third tube and the first tube, the second intermediate chamber providing fluid communication between the rebound chamber and the third flow path; and a reservoir in fluid communication with the first flow path and the second flow path.

In the shock absorbing apparatus according to an aspect of the present disclosure, during a compression stroke of the piston assembly, fluid in the compression chamber may flow to the rebound chamber through the piston valve, or to the reservoir through the penetration portion and the first flow path, or to the reservoir through the first intermediate chamber and the second flow path.

The shock absorbing apparatus according to an aspect of the present disclosure may further include a fourth tube disposed to surround the third tube, and the reservoir may be formed in a space between an outer circumferential surface of the third tube and an inner circumferential surface of the fourth tube.

The shock absorbing apparatus according to an aspect of the present disclosure may further include a second valve disposed between the first flow path and the reservoir, the second valve controlling fluid flow from the first flow path to the reservoir.

In the shock absorbing apparatus according to an aspect of the present disclosure, the second valve may be configured as an electronically controlled valve.

In the shock absorbing apparatus according to an aspect of the present disclosure, the third flow path may be in fluid communication with the compression chamber, and the shock absorbing apparatus according to an aspect of the present disclosure may further include a third valve disposed between the third flow path and the compression chamber, the third valve controlling fluid flow from the third flow path to the compression chamber.

In the shock absorbing apparatus according to an aspect of the present disclosure, the third valve may be configured as an electronically controlled valve.

In the shock absorbing apparatus according to an aspect of the present disclosure, the second valve and the third valve may be disposed side by side and adjacent to each other in a horizontal direction.

In the shock absorbing apparatus according to an aspect of the present disclosure, an inlet of the first flow path may be disposed at a portion of an inner wall of the through hole of the block, the portion being aligned with the penetration portion of the first tube.

In the shock absorbing apparatus according to an aspect of the present disclosure, the block may further have a first groove and a second groove formed along a circumferential direction on an upper side and a lower side, respectively, of a portion of an inner wall of the through hole that is aligned with the penetration portion of the first tube, and the shock absorbing apparatus according to an aspect of the present disclosure may further include a first sealing member disposed in the first groove to seal between the inner wall of the through hole and an outer circumferential surface of the first tube; and a second sealing member disposed in the second groove to seal between the inner wall of the through hole and the outer circumferential surface of the first tube.

In the shock absorbing apparatus according to an aspect of the present disclosure, the block may further have a first step, the first step being formed by a portion of an inner wall of the through hole being recessed above the first groove and supporting a lower end of the third tube.

In the shock absorbing apparatus according to an aspect of the present disclosure, an inlet of the third flow path may be disposed to provide fluid communication between the first step and the third flow path.

In the shock absorbing apparatus according to an aspect of the present disclosure, the block may further have a third groove formed along a circumferential direction on the inner wall of the through hole above the first step, and the shock absorbing apparatus according to an aspect of the present disclosure may further include a third sealing member disposed in the third groove to seal between the inner wall of the through hole and an outer circumferential surface of the third tube.

In the shock absorbing apparatus according to an aspect of the present disclosure, the block may further have a second step, the second step being formed by a portion of an upper inner wall of the through hole being recessed outward in a radial direction and supporting a lower end of the fourth tube.

According to another aspect of the present disclosure, provided is a shock absorbing apparatus comprising a block having a through hole vertically penetrating the block, and a first flow path, a second flow path, and a third flow path; a first tube extending vertically through the through hole and having a penetration portion that penetrates an inner circumferential surface and an outer circumferential surface of the first tube so that an interior of the first tube is in fluid communication with the first flow path; a piston assembly disposed inside the first tube and configured to performing a compression stroke or a rebound stroke, the piston assembly including: a piston valve that partitions the first tube into a rebound chamber on the upper side and a compression chamber on the lower side, and a piston rod coupled to the piston valve; a second tube disposed to surround a portion of the first tube that extends below the block and forming a first intermediate chamber between the second tube and the first tube, the first intermediate chamber providing fluid communication between the compression chamber and the second flow path; a first valve disposed at a lower end of the first tube, the first valve partitioning the compression chamber and the first intermediate chamber and allowing fluid in the compression chamber to flow into the first intermediate chamber; a third tube disposed to surround a portion of the first tube that extends above the block and forming a second intermediate chamber between the third tube and the first tube, the second intermediate chamber providing fluid communication between the rebound chamber and the third flow path; a reservoir in fluid communication with the first flow path and the second flow path; and a second valve disposed between the first flow path and the reservoir, the second valve being electronically controlled and configured to control fluid flow from the first flow path to the reservoir during a compression stroke of the piston assembly.

In the shock absorbing apparatus according to another aspect of the present disclosure, a damping force during a compression stroke of the piston valve may be adjusted according to an opening degree of the second valve.

In the shock absorbing apparatus according to another aspect of the present disclosure, during a compression stroke of the piston assembly, fluid in the compression chamber may flow to the reservoir through the first flow path, or to the reservoir through the first intermediate chamber and the second flow path, or to the rebound chamber through the piston valve.

In the shock absorbing apparatus according to another aspect of the present disclosure, the third flow path may be in fluid communication with the compression chamber, and the shock absorbing apparatus according to another aspect of the present disclosure may further include a third valve disposed between the third flow path and the compression chamber, the third valve being electronically controlled and configured to control fluid flow from the third flow path to the compression chamber.

In the shock absorbing apparatus according to another aspect of the present disclosure, an inlet of the first flow path may be disposed at a portion of an inner wall of the through hole of the block, the portion being aligned with the penetration portion of the first tube.

In the shock absorbing apparatus according to another aspect of the present disclosure, the block may further have a first groove and a second groove formed along a circumferential direction on an upper side and a lower side, respectively, of a portion of an inner wall of the through hole that is aligned with the penetration portion of the first tube, and the shock absorbing apparatus according to another aspect of the present disclosure may further include a first sealing member disposed in the first groove to seal between the inner wall of the through hole and an outer circumferential surface of the first tube; and a second sealing member disposed in the second groove to seal between the inner wall of the through hole and the outer circumferential surface of the first tube.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view of a shock absorbing apparatus according to an exemplary embodiment of the present disclosure.

FIG. 2 is an exploded perspective view of the shock absorbing apparatus according to an exemplary embodiment of the present disclosure.

FIG. 3 is a partially cutaway view showing a portion of the shock absorbing apparatus according to an exemplary embodiment of the present disclosure.

FIG. 4 is a longitudinal cross-sectional view of the shock absorbing apparatus according to an exemplary embodiment of the present disclosure.

FIG. 5 is an enlarged view of part A in FIG. 4.

FIG. 6 is a view showing a block of the shock absorbing apparatus according to an exemplary embodiment of the present disclosure, with a portion cut away.

FIG. 7 is a longitudinal cross-sectional perspective view of the block of the shock absorbing apparatus according to an exemplary embodiment of the present disclosure.

FIG. 8 is an enlarged view of part B in FIG. 4.

FIG. 9 is a view illustrating the flow of fluid through a first flow path and a second flow path during a compression stroke of the shock absorbing apparatus according to an exemplary embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

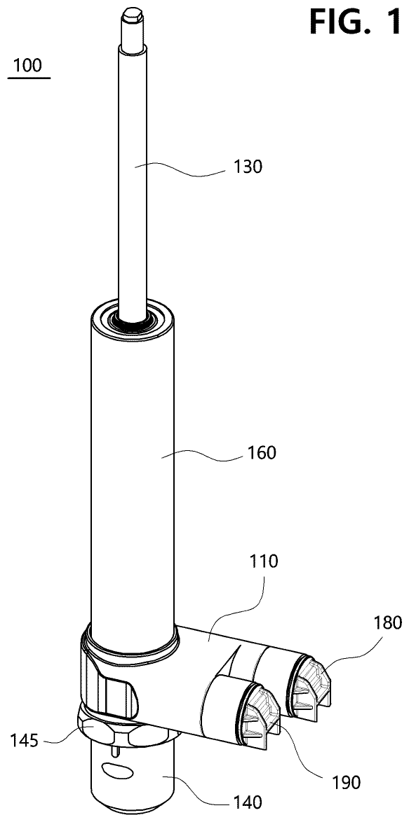

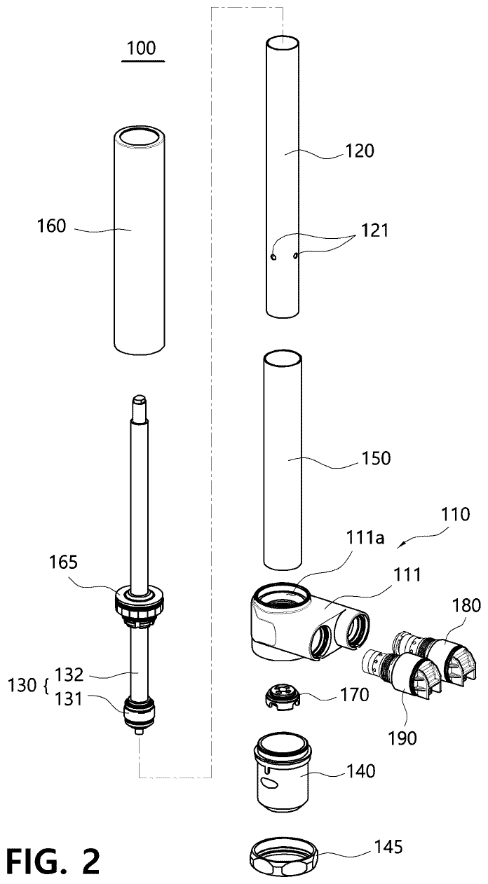

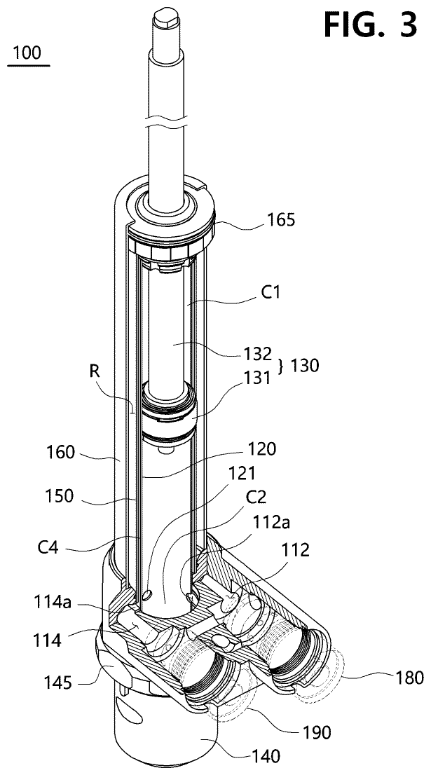

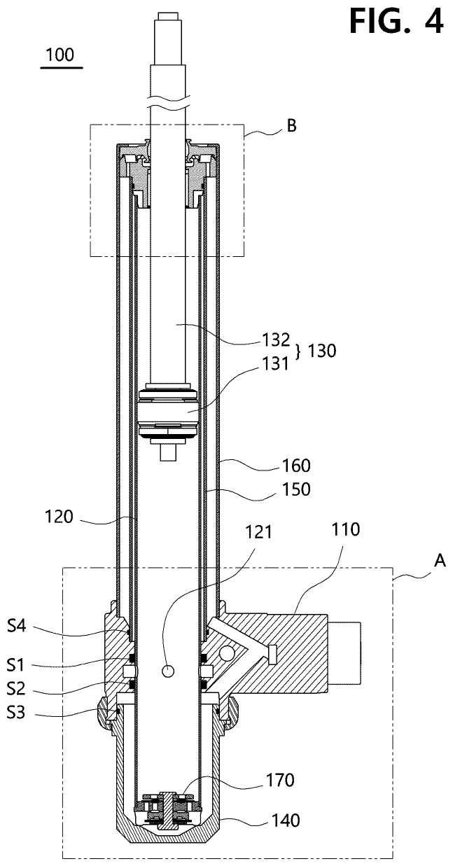

FIG. 1 is a perspective view of a shock absorbing apparatus according to an exemplary embodiment of the present disclosure. FIG. 2 is an exploded perspective view of the shock absorbing apparatus according to an exemplary embodiment of the present disclosure. FIG. 3 is a partially cutaway view showing a portion of the shock absorbing apparatus according to an exemplary embodiment of the present disclosure. FIG. 4 is a longitudinal cross-sectional view of the shock absorbing apparatus according to an exemplary embodiment of the present disclosure.

A shock absorbing apparatus 100 according to an exemplary embodiment of the present disclosure may be installed in a vehicle to absorb shocks transmitted from a road surface to the vehicle. More specifically, the shock absorbing apparatus 100 may be installed between a wheel and a vehicle body to mitigate shocks applied from the road surface to the vehicle body.

The shock absorbing apparatus 100 may be configured to allow control of a damping force. More specifically, the shock absorbing apparatus 100 may allow the damping force to be controlled through an electronic control method. In other words, the shock absorbing apparatus 100 may be used in a semi-active suspension system or an active suspension system in which the damping force is controllable.

Referring to FIGS. 1 to 4, the shock absorbing apparatus 100 may include a block 110, a first tube 120, a piston assembly 130, a second tube 140, a third tube 150, a fourth tube 160, a first valve 170, a second valve 180, and a third valve 190.

The block 110 defines the mounting positions of the first tube 120, the second tube 140, the third tube 150, and the fourth tube 160. The first tube 120, the second tube 140, the third tube 150, and the fourth tube 160 may be fastened to the block 110. In addition, the second valve 180 and the third valve 190 may be mounted in the block 110.

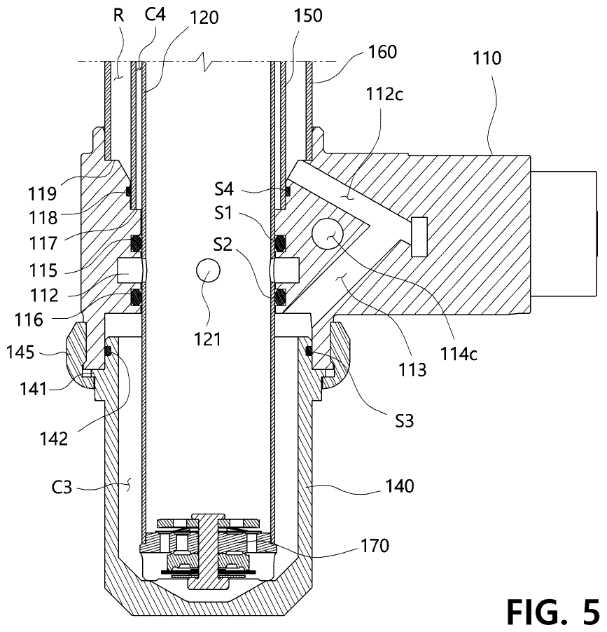

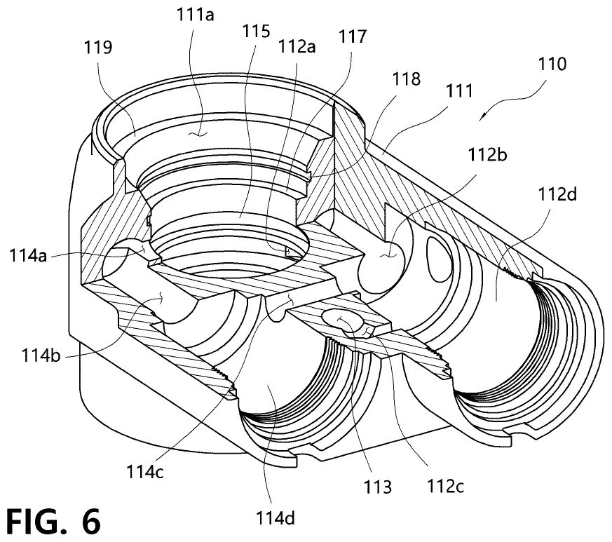

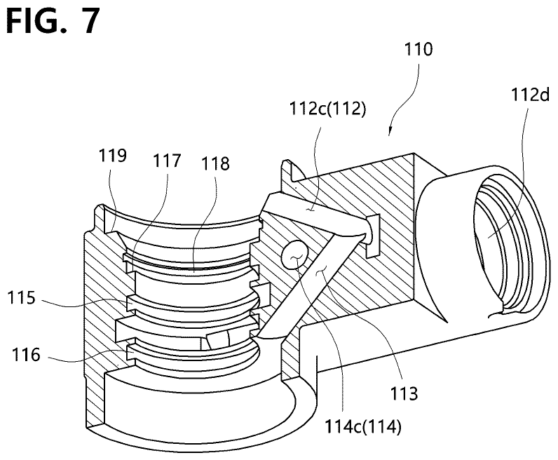

FIG. 5 is an enlarged view of part A in FIG. 4. FIG. 6 is a view showing a block of the shock absorbing apparatus according to an exemplary embodiment of the present disclosure, with a portion cut away. In addition, FIG. 7 is a longitudinal cross-sectional perspective view of the block of the shock absorbing apparatus according to an exemplary embodiment of the present disclosure.

Referring to FIGS. 5 to 7, the block 110 includes a through hole 111a vertically penetrating the block and a first flow path 112, a second flow path 113, and a third flow path 114. More specifically, the block 110 includes a block body 111 having the through hole 111a. In addition, the first flow path 112, the second flow path 113, and the third flow path 114 are formed in the block body 111.

The block body 111 is disposed to surround the outer circumferential surface of the first tube 120 that is disposed in the through hole 111a. In addition, the first flow path 112, the second flow path 113, and the third flow path 114 may be formed inside the block body 111.

The first tube 120 extends vertically through the through hole 111a. The first tube 120 includes a penetration portion 121 that penetrates the inner circumferential surface and the outer circumferential surface thereof so that the interior of the first tube 120 is in fluid communication with the first flow path 112.

For example, the first penetration portion 121 may be formed as a circular hole. In an exemplary embodiment of the present disclosure, a plurality of first penetration portions 121 may be formed along the circumferential direction of the first tube 120.

A fluid for shock absorption is filled inside the first tube 120. In other words, an operation chamber in which fluid is filled is formed inside the first tube 120. In this case, the fluid may be oil.

Referring to FIGS. 3 to 7, the penetration portion 121 of the first tube 120 may be disposed in alignment with an inlet 112a of the first flow path 112. More specifically, the inlet 112a of the first flow path 112 may be disposed at a portion of the inner wall of the through hole 111a of the block 110 that is aligned with the penetration portion 121 of the first tube 120.

The fluid introduced into the first flow path 112 through the penetration portion 121 of the first tube 120 may flow toward a reservoir R. That is, the first flow path 112 is connected to the reservoir R, which will be described later.

Referring to FIGS. 5 to 7, the first flow path 112 may include a first-1 section 112b between the inlet 112a and the second valve 180, and a first-2 section 112c between the second valve 180 and the reservoir R, with reference to the second valve 180 disposed in the first flow path 112.

In an exemplary embodiment of the present disclosure, the first-1 section 112b may be disposed on a plane perpendicular to the longitudinal direction of the first tube 120. In addition, the first-2 section 112c may include a portion extending vertically while forming a predetermined angle with respect to the longitudinal direction of the first tube 120.

In relation to the placement of the first tube 120, the block 110 further includes a first groove 115 and a second groove 116, which are respectively formed along the circumferential direction on the upper and lower sides of the portion of the inner wall of the through hole 111a that is aligned with the penetration portion 121 of the first tube 120.

Referring to FIGS. 4 and 5, a first sealing member S1 is disposed in the first groove 115 to seal between the inner wall of the through hole 111a and the outer circumferential surface of the first tube 120. In addition, a second sealing member S2 is disposed in the second groove 116 to seal between the inner wall of the through hole 111a and the outer circumferential surface of the first tube 120. The first sealing member S1 and the second sealing member S2 may be O-rings.

The piston assembly 130 moves vertically within the first tube 120 and performs shock absorption. The piston assembly 130 includes a piston valve 131 and a piston rod 132.

The piston valve 131 is disposed inside the first tube 120 to partition the first tube 120 into a rebound chamber C1 on the upper side and a compression chamber C2 on the lower side. The piston valve 131 may include one or more flow paths and valves that allow or block the flow of fluid between the rebound chamber C1 and the compression chamber C2.

The piston rod 132 is coupled to the piston valve 131. For example, the lower end of the piston rod 132 is coupled to the piston valve 131, and the upper end of the piston rod 132 may be coupled to the vehicle body.

The piston assembly 130 performs a compression stroke or a rebound stroke inside the first tube 120. Here, the compression stroke refers to movement of the piston assembly 130 from the upper side to the lower side inside the first tube 120, that is, from the rebound chamber C1 toward the compression chamber C2. In addition, the rebound stroke refers to movement of the piston assembly 130 from the lower side to the upper side inside the first tube 120, that is, from the compression chamber C2 toward the rebound chamber C1.

During the compression stroke or the rebound stroke of the piston assembly 130, fluid may flow through the piston valve 131. More specifically, during the compression stroke, fluid in the compression chamber C2 may flow to the rebound chamber C1 through the piston valve 131. In addition, during the rebound stroke, fluid in the rebound chamber C1 may flow to the compression chamber C2 through the piston valve 131.

In an exemplary embodiment of the present disclosure, a lower boundary of the compression stroke of the piston assembly 130 may be a set point located at or above the penetration portion 121 of the first tube 120. That is, during the compression stroke, the piston assembly 130 moves from the upper side to the lower side of the penetration portion 121, but the piston valve 131 may move to a set point located at or above the penetration portion 121.

The second tube 140 is disposed to surround a portion of the first tube 120 that extends below the block 110. The second tube 140 forms a first intermediate chamber C3 between the second tube 140 and the first tube 120, the first intermediate chamber C3 providing fluid communication between the compression chamber C2 and the second flow path 113.

The second tube 140 has an inner diameter greater than that of the first tube 120. Accordingly, the first intermediate chamber C3 may be formed between the inner circumferential surface of the second tube 140 and the outer circumferential surface of the first tube 120. In addition, the second tube 140 may be disposed concentrically with the first tube 120.

Fluid in the first intermediate chamber C3 may flow toward the reservoir R through the second flow path 113. That is, the second flow path 113 is connected to the reservoir R. In an exemplary embodiment of the present disclosure, the second flow path 113 may include a portion extending vertically while forming a predetermined angle with respect to the longitudinal direction of the first tube 120.

Referring to FIG. 5, the second flow path 113 is in fluid communication with the first-2 section 112c of the first flow path 112. Accordingly, fluid in the first intermediate chamber C3 may flow to the reservoir R through the second flow path 113 and the first-2 section 112c of the first flow path 112.

Referring to FIGS. 4 and 5, the second tube 140 may have a closed lower end and an open upper end. The second tube 140 may be fastened to the lower end of the block 110. More specifically, the second tube 140 may include a flange 141 protruding radially outward from its outer circumferential surface, and may be coupled to the block 110 by a fastening member 145 that supports the flange 141 and is fastened to the lower end of the block 110. For example, the fastening member 145 may be a nut.

The second tube 140 includes a portion extending above the flange 141, and the portion extending above the flange 141 may be inserted into the through hole 111a of the block 110. In this case, the flange 141 may be disposed so as to engage with the block body 111 around the lower end of the through hole 111a of the block 110.

The second tube 140 may include a second tube groove 142 formed along the circumferential direction on the outer circumferential surface of the portion extending above the flange 141. A third sealing member S3 is disposed in the second tube groove 142 to seal between the inner wall of the through hole 111a and the outer circumferential surface of the second tube 140.

The third tube 150 is disposed to surround a portion of the first tube 120 that extends above the block 110. The third tube 150 forms a second intermediate chamber C4 between the third tube 150 and the first tube 120, the second intermediate chamber C4 providing fluid communication between the rebound chamber C1 and the third flow path 114.

The third tube 150 has an inner diameter greater than that of the first tube 120. Accordingly, the second intermediate chamber C4 may be formed between the inner circumferential surface of the third tube 150 and the outer circumferential surface of the first tube 120. In addition, the third tube 150 may be disposed concentrically with the first tube 120.

In relation to the placement of the third tube 150, referring to FIGS. 3 to 7, the block 110 has a first step 117, the first step being formed by a portion of the inner wall of the through hole 111a being recessed outward in a radial direction above the first groove 115 and supporting a lower end of the third tube 150.

An inlet 114a of the third flow path 114 may be disposed to provide fluid communication between the first step 117 and the third flow path 114. In other words, the inlet 114a of the third flow path 114 may be disposed on the first step 117.

The third flow path 114 is connected to the compression chamber C. Fluid introduced into the third flow path 114 through the inlet 114a of the third flow path 114 may flow to the compression chamber C. More specifically, the third flow path 114 is in fluid communication with the first-1 section 112b of the first flow path 112, and the fluid introduced into the third flow path 114 may flow through the third flow path 114, pass through the first-1 section 112b of the first flow path 112, and then flow to the compression chamber C through the penetration portion 121 of the first tube 120.

Referring to FIGS. 3 to 7, the third flow path 114 may include a third-1 section 114b between the inlet 114a of the third flow path 114 and the third valve 190, and a third-2 section 114c between the third valve 190 and the first-1 section 112b of the first flow path 112, with reference to the third valve 190 disposed in the third flow path 114.

In an exemplary embodiment of the present disclosure, the third-1 section 114b may be disposed on a plane perpendicular to the longitudinal direction of the first tube 120. The third-1 section 114b may be arranged in parallel on the same plane as the first-1 section 112b of the first flow path 112. In addition, the third-2 section 114c may be disposed at a predetermined angle with respect to the third-1 section 114b on the plane perpendicular to the longitudinal direction of the first tube 120. For example, the third-2 section 114c may form a 90-degree angle with the third-1 section 114 b.

In relation to the placement of the third tube 150, the block 110 may further include a third groove 118 formed along the circumferential direction on the inner wall of the through hole 111a above the first step 117. A fourth sealing member S4 is disposed in the third groove 118 to seal between the inner wall of the through hole 111a and the outer circumferential surface of the third tube 150.

The fourth tube 160 is disposed to surround the third tube 150. The fourth tube 160, together with the third tube 150, forms the reservoir R. More specifically, a storage space of the reservoir R may be formed between the third tube 150 and the fourth tube 160.

The fourth tube 160 has an inner diameter greater than that of the third tube 150. Accordingly, the reservoir R may be formed between the inner circumferential surface of the fourth tube 160 and the outer circumferential surface of the third tube 150. In addition, the fourth tube 160 may be disposed concentrically with the third tube 150.

The reservoir R is in fluid communication with the first flow path 112 and the second flow path 113. During the compression stroke of the shock absorbing apparatus 100, the reservoir R may receive fluid flowing from the compression chamber C into the first flow path 112 or the second flow path 113. More specifically, during the compression stroke of the shock absorbing apparatus 100, fluid inside the compression chamber C may flow to the reservoir R through the first flow path 112, or flow to the reservoir R through the second flow path 113 and the first-2 section 112c of the first flow path 112.

In relation to the placement of the fourth tube 160, referring to FIGS. 3 to 7, the block 110 may have a second step 119, the second step being formed by a portion of the upper inner wall of the through hole 111a being recessed outward in a radial direction and supporting a lower end of the fourth tube 160.

A lower end of the fourth tube 160 is supported by the second step 119, and the outer circumferential surface of the lower end of the fourth tube 160 may be supported by the inner wall of the through hole 111a that extends above the second step 119.

The first valve 170 is disposed at a lower end of the first tube 120. The first valve 170 partitions the compression chamber C2 and the first intermediate chamber C3, and allows fluid in the compression chamber C2 to flow into the first intermediate chamber C3.

The first valve 170 may have a disk shape and may be disposed to cover the lower end of the first tube 120. The first valve 170 may include one or more flow paths and one or more regulating means (e.g., disk valves) capable of controlling the flow within the flow paths.

When the piston assembly 130 performs a compression stroke, the fluid inside the compression chamber C2 is pressurized downward by the piston valve 131, and the fluid located at the lower end of the compression chamber C2 may flow from the compression chamber C2 to the first intermediate chamber C3 through the first valve 170.

The second valve 180 is disposed between the first flow path 112 and the reservoir R to control the flow of fluid from the first flow path 112 to the reservoir R. Referring to FIGS. 3 and 6, in relation to the placement of the second valve 180, the block 110 may include a first mounting portion 112d. More specifically, the first mounting portion 112d may form a boundary between the first-1 section 112b and the first-2 section 112c of the first flow path 112.

The second valve 180 may be configured as an electronically controlled valve. For example, the second valve 180 may be a solenoid valve.

Adjustment of the damping force during the compression stroke may be achieved through the control of the second valve 180. More specifically, the flow of fluid from the first-1 section 112b to the first-2 section 112c of the first flow path 112 may be regulated according to the control of the second valve 180.

The third valve 190 is disposed between the third flow path 114 and the compression chamber C2 to control the flow of fluid from the third flow path 114 to the compression chamber C2. Referring to FIGS. 3 and 6, in relation to the placement of the third valve 190, the block 110 may include a second mounting portion 114d. More specifically, the second mounting portion 114d may form a boundary between the third-1 section 114b and the third-2 section 114c of the third flow path 114.

The third valve 190 may be configured as an electronically controlled valve. For example, the third valve 190 may be a solenoid valve.

Adjustment of the damping force during the rebound stroke may be achieved through the control of the third valve 190. More specifically, the flow of fluid from the third-1 section 114b to the third-2 section 114c of the third flow path 114 may be regulated according to the control of the third valve 190.

In an exemplary embodiment of the present disclosure, the second valve 180 and the third valve 190 may be disposed side by side and adjacent to each other in a horizontal direction. By arranging the second valve 180 and the third valve 190 side by side in the horizontal direction in this manner, interference between the shock absorbing apparatus 100 and other components in the vehicle can be reduced, and space efficiency can be improved when installing the shock absorbing apparatus 100 in the vehicle.

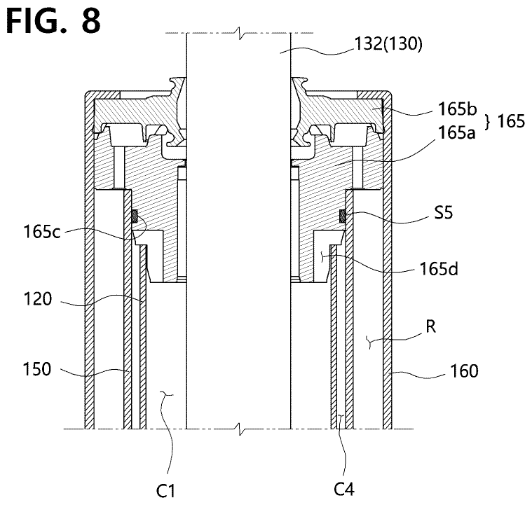

FIG. 8 is an enlarged view of part B in FIG. 4.

Referring to FIG. 8, the shock absorbing apparatus 100 may include a top cover 165 that is disposed to seal upper ends of the first tube 120, the third tube 150, and the fourth tube 160. In an exemplary embodiment of the present disclosure, the top cover 165 may include a first cover member 165a and a second cover member 165b.

The first cover member 165a seals the upper ends of the first tube 120 and the third tube 150, while being disposed to provide fluid communication between the rebound chamber C1 and the second intermediate chamber C4. The piston rod 132 of the piston assembly 130 may be disposed to pass through the first cover member 165a.

The first cover member 165a may include a cover groove 165c recessed along the circumferential direction on an outer peripheral portion that comes into contact with the inner circumferential surface of the third tube 150. A fifth sealing member S5 is disposed in the cover groove 165c to seal between the first cover member 165a and the third tube 150. The fifth sealing member S5 may be an O-ring.

The first cover member 165a may include a cover flow path 165d that provides fluid communication between the rebound chamber C1 and the second intermediate chamber C4. During the rebound stroke of the shock absorbing apparatus 100, a portion of the fluid in the rebound chamber C1 may flow to the second intermediate chamber C4 through the cover flow path 165d.

The second cover member 165b is disposed above the first cover member 165a to cover the upper end of the fourth tube 160. The piston rod 132 of the piston assembly 130 may be disposed to pass through the second cover member 165b.

The configuration of the shock absorbing apparatus 100 according to an exemplary embodiment of the present disclosure has been described in detail above. Hereinafter, the operation of the shock absorbing apparatus 100 will be described.

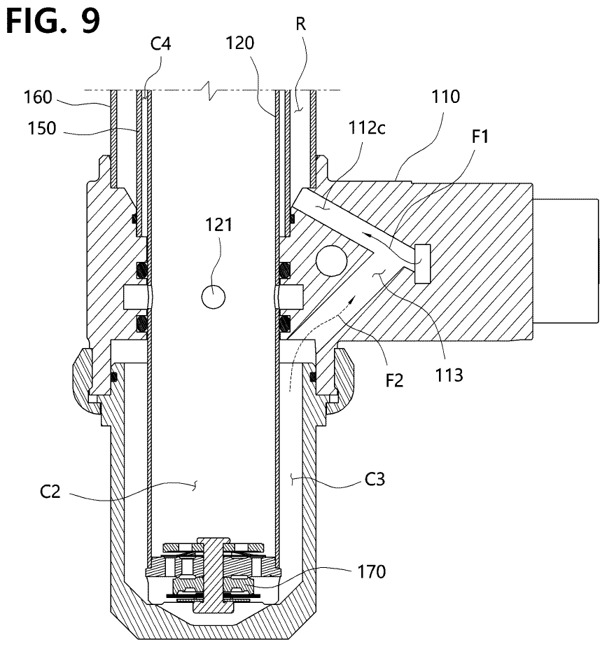

FIG. 9 is a view illustrating the flow of fluid through a first flow path and a second flow path during a compression stroke of the shock absorbing apparatus according to an exemplary embodiment of the present disclosure. In FIG. 9, the piston assembly 130 is omitted.

Referring to FIG. 9, during the compression stroke of the shock absorbing apparatus 100, a portion of the fluid in the compression chamber C2 may flow to the reservoir R through the penetration portion 121 and the first flow path 112. More specifically, the fluid F1 introduced into the first flow path 112 through the inlet 112a of the first flow path 112, which is aligned with the penetration portion 121, flows to the first-2 section 112c via the first-1 section 112b and the second valve 180.

At this time, the flow of fluid from the first-1 section 112b to the first-2 section 112c may be regulated according to the control of the second valve 180. That is, the damping force during the compression stroke may be adjusted through the control of the second valve 180.

Another portion of the fluid in the compression chamber C2 may flow to the reservoir R through the first intermediate chamber C3 and the second flow path 113. More specifically, the fluid F2 introduced into the first intermediate chamber C3 through the first valve 170 disposed at the lower end of the compression chamber C2 may flow to the reservoir R via the second flow path 113 and the first-2 section 112c of the first flow path 112.

During the compression stroke of the shock absorbing apparatus 100, yet another portion of the fluid in the compression chamber C2 may flow to the rebound chamber C1 through the piston valve 131.

As described above, according to the present disclosure, parallel flow paths are provided from the compression chamber C2 to the reservoir R during the compression stroke of the shock absorbing apparatus 100. This allows for improved tuning performance for the compression stroke and enables optimal implementation of ride comfort in the vehicle.

Meanwhile, during the rebound stroke of the shock absorbing apparatus 100, a portion of the fluid in the rebound chamber C1 may flow to the compression chamber C2 through the piston valve 131 of the piston assembly 130.

In addition, during the rebound stroke of the shock absorbing apparatus 100, another portion of the fluid in the rebound chamber C1 may be pressurized by the piston valve 131 and flow from the rebound chamber C1 to the second intermediate chamber C4. The fluid introduced into the second intermediate chamber C4 may then flow to the compression chamber C2 through the third flow path 114.

More specifically, the fluid introduced from the second intermediate chamber C4 into the third flow path 114 through the inlet 114a of the third flow path 114, which is in fluid communication with the first step 117, may flow to the first-1 section 112b of the first flow path 112 via the third-1 section 114b, the third valve 190, and the third-2 section 114c of the third flow path 114, and then flow into the compression chamber C2 through the penetration portion 121.

At this time, the flow of fluid from the third-1 section 114b to the third-2 section 114c may be regulated according to the control of the third valve 190. That is, the damping force during the rebound stroke may be adjusted through the control of the third valve 190.

According to the above configuration, the shock absorbing apparatus according to an aspect of the present disclosure enhances the tuning performance of the compression stroke by providing an additional parallel flow path during the compression stroke.

Advantageous effects of the present disclosure are not limited to the above-described effects, and should be understood to include all effects that can be inferred from the configuration of the disclosure described in the detailed description or claims of the present disclosure.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A shock absorbing apparatus comprising:
a block having a through hole vertically penetrating the block, and a first flow path, a second flow path, and a third flow path;
a first tube extending vertically through the through hole and having a penetration portion that penetrates an inner circumferential surface and an outer circumferential surface of the first tube so that an interior of the first tube is in fluid communication with the first flow path;
a piston assembly disposed inside the first tube and configured to performing a compression stroke or a rebound stroke, the piston assembly including: a piston valve that partitions the first tube into a rebound chamber on the upper side and a compression chamber on the lower side, and a piston rod coupled to the piston valve;
a second tube disposed to surround a portion of the first tube that extends below the block and forming a first intermediate chamber between the second tube and the first tube, the first intermediate chamber providing fluid communication between the compression chamber and the second flow path;
a first valve disposed at a lower end of the first tube, the first valve partitioning the compression chamber and the first intermediate chamber and allowing fluid in the compression chamber to flow into the first intermediate chamber;
a third tube disposed to surround a portion of the first tube that extends above the block and forming a second intermediate chamber between the third tube and the first tube, the second intermediate chamber providing fluid communication between the rebound chamber and the third flow path; and
a reservoir in fluid communication with the first flow path and the second flow path.

2. The apparatus of claim 1,
wherein, during a compression stroke of the piston assembly, fluid in the compression chamber flows
to the rebound chamber through the piston valve,
or to the reservoir through the penetration portion and the first flow path,
or to the reservoir through the first intermediate chamber and the second flow path.

3. The apparatus of claim 1,
further comprising a fourth tube disposed to surround the third tube,
wherein the reservoir is formed in a space between an outer circumferential surface of the third tube and an inner circumferential surface of the fourth tube.

4. The apparatus of claim 1, further comprising a second valve disposed between the first flow path and the reservoir, the second valve controlling fluid flow from the first flow path to the reservoir.

5. The apparatus of claim 4, wherein the second valve is configured as an electronically controlled valve.

6. The apparatus of claim 4,
wherein the third flow path is in fluid communication with the compression chamber, and
wherein the apparatus further comprises a third valve disposed between the third flow path and the compression chamber, the third valve controlling fluid flow from the third flow path to the compression chamber.

7. The apparatus of claim 6, wherein the third valve is configured as an electronically controlled valve.

8. The apparatus of claim 6, wherein the second valve and the third valve are disposed side by side and adjacent to each other in a horizontal direction.

9. The apparatus of claim 1, wherein an inlet of the first flow path is disposed at a portion of an inner wall of the through hole of the block, the portion being aligned with the penetration portion of the first tube.

10. The apparatus of claim 1,
wherein the block further has a first groove and a second groove formed along a circumferential direction on an upper side and a lower side, respectively, of a portion of an inner wall of the through hole that is aligned with the penetration portion of the first tube, and
wherein the apparatus further comprises:
a first sealing member disposed in the first groove to seal between the inner wall of the through hole and an outer circumferential surface of the first tube; and
a second sealing member disposed in the second groove to seal between the inner wall of the through hole and the outer circumferential surface of the first tube.

11. The apparatus of claim 10, wherein the block further has a first step, the first step being formed by a portion of an inner wall of the through hole being recessed above the first groove and supporting a lower end of the third tube.

12. The apparatus of claim 11, wherein an inlet of the third flow path is disposed to provide fluid communication between the first step and the third flow path.

13. The apparatus of claim 11,
wherein the block further has a third groove formed along a circumferential direction on the inner wall of the through hole above the first step, and
wherein the apparatus further comprises a third sealing member disposed in the third groove to seal between the inner wall of the through hole and an outer circumferential surface of the third tube.

14. The apparatus of claim 3, wherein the block further has a second step, the second step being formed by a portion of an upper inner wall of the through hole being recessed outward in a radial direction and supporting a lower end of the fourth tube.

15. A shock absorbing apparatus comprising:
a block having a through hole vertically penetrating the block, and a first flow path, a second flow path, and a third flow path;
a first tube extending vertically through the through hole and having a penetration portion that penetrates an inner circumferential surface and an outer circumferential surface of the first tube so that an interior of the first tube is in fluid communication with the first flow path;
a piston assembly disposed inside the first tube and configured to performing a compression stroke or a rebound stroke, the piston assembly including: a piston valve that partitions the first tube into a rebound chamber on the upper side and a compression chamber on the lower side, and a piston rod coupled to the piston valve;
a second tube disposed to surround a portion of the first tube that extends below the block and forming a first intermediate chamber between the second tube and the first tube, the first intermediate chamber providing fluid communication between the compression chamber and the second flow path;
a first valve disposed at a lower end of the first tube, the first valve partitioning the compression chamber and the first intermediate chamber and allowing fluid in the compression chamber to flow into the first intermediate chamber;
a third tube disposed to surround a portion of the first tube that extends above the block and forming a second intermediate chamber between the third tube and the first tube, the second intermediate chamber providing fluid communication between the rebound chamber and the third flow path;
a reservoir in fluid communication with the first flow path and the second flow path; and
a second valve disposed between the first flow path and the reservoir, the second valve being electronically controlled and configured to control fluid flow from the first flow path to the reservoir during a compression stroke of the piston assembly.

16. The apparatus of claim 15, wherein a damping force during a compression stroke of the piston valve is adjusted according to an opening degree of the second valve.

17. The apparatus of claim 15,
wherein, during a compression stroke of the piston assembly, fluid in the compression chamber flows
to the reservoir through the first flow path,
or to the reservoir through the first intermediate chamber and the second flow path,
or to the rebound chamber through the piston valve.

18. The apparatus of claim 15,
wherein the third flow path is in fluid communication with the compression chamber, and
wherein the apparatus further comprises a third valve disposed between the third flow path and the compression chamber, the third valve being electronically controlled and configured to control fluid flow from the third flow path to the compression chamber.

19. The apparatus of claim 15, wherein an inlet of the first flow path is disposed at a portion of an inner wall of the through hole of the block, the portion being aligned with the penetration portion of the first tube.

20. The apparatus of claim 15,
wherein the block further has a first groove and a second groove formed along a circumferential direction on an upper side and a lower side, respectively, of a portion of an inner wall of the through hole that is aligned with the penetration portion of the first tube, and
wherein the apparatus further comprises:
a first sealing member disposed in the first groove to seal between the inner wall of the through hole and an outer circumferential surface of the first tube; and
a second sealing member disposed in the second groove to seal between the inner wall of the through hole and the outer circumferential surface of the first tube.
